(19) United States
(12) Patent Application Publication
(10) Pub. No.: US 2023/0307727 A1
(43) Pub. Date: Sep. 28, 2023

(54) ANALYSIS SYSTEM FOR LITHIUM SECONDARY BATTERY AND ANALYSIS METHOD USING SAME

(71) Applicants: Hyundai Motor Company, Seoul (KR); Kia Corporation, Seoul (KR); Institute for Research & Industry Cooperation Pusan National University, Busan (KR)

(72) Inventors: Sung Hoo Jung, Changwon (KR); Ju Yeon Lee, Busan (KR); Gyeong Jun Chung, Daejeon (KR); Jong Jung Kim, Suwon (KR); Sang Mo Kim, Hwaseong (KR); Yoon Jae Han, Yongin (KR); Ji Ung Jeong, Busan (KR); Yu Jeong Min, Busan (KR); So Young Joo, Busan (KR); Heon Cheol Shin, Busan (KR)

(21) Appl. No.: 18/080,565

(22) Filed: Dec. 13, 2022

(30) Foreign Application Priority Data
Mar. 22, 2022 (KR) 10-2022-0035075

(51) Int. Cl. H01M 10/42; H01M 10/48; H01M 10/0525; H01M 10/0585; H01M 50/107; H01M 50/152; H01M 50/186

(52) U.S. Cl. CPC H01M 10/4285; H01M 10/48; H01M 10/0525; H01M 10/0585; H01M 50/107; H01M 50/152; H01M 50/186

(57) ABSTRACT

A system for analyzing a solid-state battery and a lithium rechargeable battery such as a lithium ion battery, and an analysis method using the system are proposed. The analysis system for a lithium secondary battery includes a housing having an accommodation space therein, and a lithium secondary battery accommodated in the accommodation space of the housing and being chargeable and dischargeable, in which the lithium secondary battery includes: an electrolyte part. The system also includes a first electrode part positioned on a side of the electrolyte part, and a second electrode part positioned on another side of the electrolyte part, in which the electrolyte part includes a matrix including a solid electrolyte having conductivity for lithium ions, one or more reference electrodes inserted in the matrix, and one or more SoC adjusters inserted in the matrix at a predetermined distance in a width direction from the reference electrode.

### CROSS REFERENCE TO RELATED APPLICATION

The present application claims, under 35 U.S.C. § 119(a), priority to Korean Patent Application No. 10-2022-0035075, filed Mar. 22, 2022, the entire contents of which is incorporated herein for all purposes by this reference.

### BACKGROUND OF THE DISCLOSURE

### 1. Field of the Disclosure

The present disclosure relates to a system for analyzing a lithium secondary battery such as an all-solid-state battery, a lithium ion battery, etc., and an analysis method using the system.

### 2. Background

A 3-electrodes cell of the prior art for analyzing resistance in a lithium secondary battery generates structural distortion due to insertion of a reference electrode and may influence electrochemical signals due to contamination of the reference electrode, etc.

A symmetric cell is commonly manufactured by adjusting a State of Charge (SoC) in two-unit cells through charge/discharge and then separating the unit cells. An electrode may be damaged and an electrolyte may be contaminated in the above process, and it is difficult to implement cells with the same internal structure as actual products.

### SUMMARY OF THE DISCLOSURE

An objective of the present disclosure is to provide an analysis system and method for a lithium secondary battery, the system and method being able to implement all of a symmetric cell, a 2-electrode cell, and a 3-electrode cell in a same cell.

The objects of the present disclosure are not limited to the objects described above. The objects of the present disclosure will be clearer from the following description and will be accomplished through the means and combinations thereof described in claims.

A analysis system for a lithium secondary battery according to an embodiment of the present disclosure may include a housing comprising an accommodation space therein, and a lithium secondary battery accommodated in the accommodation space of the housing and being chargeable and dischargeable, in which the lithium secondary battery may include: an electrolyte part; a first electrode part disposed on one side of the electrolyte part; and a second electrode part disposed on another side of the electrolyte part, in which the electrolyte part may include: a matrix including a solid electrolyte having lithium ion conductivity; one or more reference electrodes inserted in the matrix; and at least one SoC adjustment member inserted in the matrix and spaced apart from the reference electrode in a thickness direction by a predetermined distance.

The housing may include: a body part having a cylindrical shape and having a first through hole formed in a vertical direction therethrough and a second through hole formed in a side surface thereof, the second through hole being configured to communicate with the first through hole; a first conductive part including a first substrate and having a plate shape and a first protrusion member protruding from the first substrate and having a size and shape corresponding to a size and shape of the first through hole; and a second conductive part including a second substrate having a plate shape and a second protrusion member protruding from the second substrate and having a size and shape corresponding to a size and shape of the second through hole.

The first protruding member may be inserted into the first through hole at an upper part of the body part.

The second protruding member may be inserted into the first through hole at a lower part of the body part.

The lithium secondary battery may be positioned in a space between the first protrusion member and the second protrusion member in the first through hole.

The body part may further include insulating member disposed on surfaces of the first through hole and the second through hole.

The matrix may include a solid electrolyte.

The housing may include: a first case part being open on one side and having an accommodation space therein; and a second case part covering the open side of the first case, and the lithium secondary battery may be positioned in the accommodation space.

The housing may further include a sealing member positioned at a joint of the first case part and the second case part and sealing the accommodation space from the outside.

The analysis system may further include a pressing part interposed between the housing and the lithium secondary battery, and the pressing part may include: a pressing member having a flat shape with a predetermined area; and an elastic member interposed between the pressing member and the housing and applying elasticity to the pressing member.

The matrix may include a plurality of separators impregnated with electrolytes, and the reference electrode and the at least one SoC adjustment member may be inserted between the plurality of separators.

The reference electrode may have a bar shape, and one end of the reference electrode may be inserted in the matrix and another end of the reference electrode is exposed to the outside through the housing.

The reference electrode may include a wire coated by a precious metal.

The wire may include at least one selected from a group of tungsten (W), aluminum (Al), nickel (Ni), stainless steel (SUS), and/or any combination thereof.

The precious metal may include at least one precious metal selected from a group of gold (Au), silver (Ag), white gold (Pt), and/or any combination thereof.

The at least one SoC adjustment member may include: a plate unit inserted in the matrix and having a predetermined area; and an extension unit having a first end connected to the flat plate unit and a second end exposed to the outside through the housing.

The at least one SoC adjustment member may include at least one selected from a group of tungsten (W), aluminum (Al), nickel (Ni), stainless steel (SUS), and/or any combination thereof, and the at least one SoC adjustment member may be in a mesh form or a foam form.

The SoC adjustment member may be coated with at least one precious metal selected from a group of: gold (Au), silver (Ag), white gold (Pt), and/or any combination thereof.

An analysis method for a lithium secondary battery according to any of the above explained embodiments of the present disclosure includes: a first step of giving a positive polarity to the first electrode part and giving a negative polarity to the SoC adjustment member; a second step of applying a predetermined anodic current to the lithium secondary battery for a predetermined time: a third step of giving a positive polarity to the second electrode part and giving a negative polarity to the SoC adjustment member; and a fourth step of applying the same anodic current as that in the second step to the lithium secondary battery for the same amount of predetermined time as performed in the second step.

The analysis method may further include: a fifth step of giving a positive polarity to the first electrode part and giving a negative polarity to the second electrode part; a sixth step of applying the same anodic current as that in the fourth step to the lithium secondary battery for half of the amount of predetermined time in the fourth step; a seventh step of giving a positive polarity to the first electrode part and giving a negative polarity to the second electrode part; and an eighth step of applying the same anodic current as that in the sixth step to the lithium secondary battery for the same amount of predetermined time as that in the sixth step.

The analysis met may repeat the third step to the eighth step.

According to the present disclosure, it is possible to achieve an analysis system and method for a lithium secondary battery, the system and method being able to implement all of a symmetric cell, a 2-electrode cell, and a 3-electrode cell in a same cell.

The present disclosure minimizes errors of electrochemical analysis cells and provides convenience for analysis. That is, the present disclosure remarkably reduces difficulties in analysis due to cathode/anode overlap resistance generated in resistance measurement of a 2-electrode unit cell, a signal change according to a reference electrode position of a 3-electrode unit cell, signal distortion according to structural distortion, damage to an electrode in manufacturing of symmetric cells, etc.

The present disclosure provides a SoC adjusting electrode and a reference electrode in a common cell, so it is possible to implement a symmetric cell having various SoCs. Further, it is also possible to determine whether a cathode and an anode of the symmetric cell have the same SoC/SoH (State of health) through the reference electrode.

The present disclosure provides a common characteristic in which symmetric cell and 3-electrode tests are simultaneously performed unlike the single symmetric cell test or a single 3-electrode test. According to the present disclosure, it is possible to more deeply analyze resistance by simultaneously obtaining and analyzing a symmetric cell signal and a 3-electrode cell signal.

The present disclosure can be used for all lithium secondary batteries regardless of the kinds of electrolytes such as a liquid electrolyte and a solid electrolyte, and can provide various designs in accordance with the position of a reference electrode, and the shapes of an electrode for adjusting a SoC, a membrane, and a reference electrode.

The effects of the present disclosure are not limited to the effects described above. The effects of the present disclosure should be construed as including all effects that can be inferred from the following description.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 shows a first embodiment of an analysis system for a lithium secondary battery according to the present disclosure;

FIG. 2 shows a cross-sectional view of a body part of FIG. 1;

FIG. 3 shows a reference electrode and a matrix according to the first embodiment of the present disclosure;

FIG. 4 shows a plan view of a SoC adjustment member and the matrix according to the first embodiment of the present disclosure;

FIG. 5 shows a second embodiment of an analysis system for a lithium secondary battery according to the present disclosure;

FIG. 6 shows a plan view of the analysis system for a lithium secondary battery according to the second embodiment of the present disclosure;

FIG. 7 shows a reference electrode and a matrix according to the second embodiment of the present disclosure;

FIG. 8 shows a plan view of a SoC adjustment member and the matrix according to the second embodiment of the present disclosure;

FIG. 9 shows a first embodiment of a method of analyzing a lithium secondary battery according to the present disclosure;

FIG. 10 shows a second embodiment of a method of analyzing a lithium secondary battery according to the present disclosure;

FIGS. 11A to 11D show the results of analyzing a solid-state battery using the method shown in FIG. 9 and when a SoC was adjusted into 0, 10, 30, and 50, respectively; and

FIGS. 12A to 12D show the results of analyzing a lithium ion battery including a liquid electrolyte using the method shown in FIG. 9 and when a SoC was adjusted into 0, 10, 30, and 50, respectively.

### DETAILED DESCRIPTION OF THE DISCLOSURE

The above-mentioned objectives of the present disclosure, other objectives, features, and advantages would be easily understood through the following exemplary embodiments related to the accompanying drawings. However, the present disclosure is not limited to the embodiments described herein and may be implemented by other ways. On the contrary, the embodiments disclosed herein are provided so that the disclosed contents can be made through and complete and the spirit of the present disclosure can be sufficiently transmitted to those skilled in the art.

Similar reference numerals are assigned to similar components in the following description of drawings. In the accompanying drawings, the dimensions are structures were exaggerated larger than the actual dimensions to make the present disclosure clear. Terms used in the specification, “first”, “second”, etc., may be used to describe various components, but the components are not to be construed as being limited to the terms. The terms are used only to distinguish one component from another component. For example, the ‘first’ component may be named the ‘second’ component, and vice versa, without departing from the scope of the present disclosure. Singular forms are intended to include plural forms unless the context clearly indicates otherwise.

It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof. When an element such as a layer, a film, a region, and a plate is “on” another component, it can be directly on the other element or intervening elements may be present therebetween. When an element such as a layer, a film, a region, and a plate is “beneath” another component, it can be directly beneath the other element or intervening elements may be present therebetween.

Unless stated otherwise, all the numerals, value, and/or expressions showing components, reaction conditions, and the amounts of polymer compositions and mixtures used herein are approximate quantities to which various uncertainties in measurement, which are generated when these numbers basically obtain these values from others, are reflected, so they should be construed as being modified by a term “approximately”. Further, when a numeral range is disclosed herein, the range is continuous and includes all values from a minimum value to a maximum value including the maximum value in the range unless stated otherwise. Further, when this range indicates an integer number, all integer values from a minimum value to a maximum value including the maximum value are included unless stated otherwise.

An analysis system for a lithium secondary battery according to the present disclosure may include: a housing having an accommodation space therein; and a lithium secondary battery accommodated in the accommodation space of the housing and being chargeable and dischargeable.

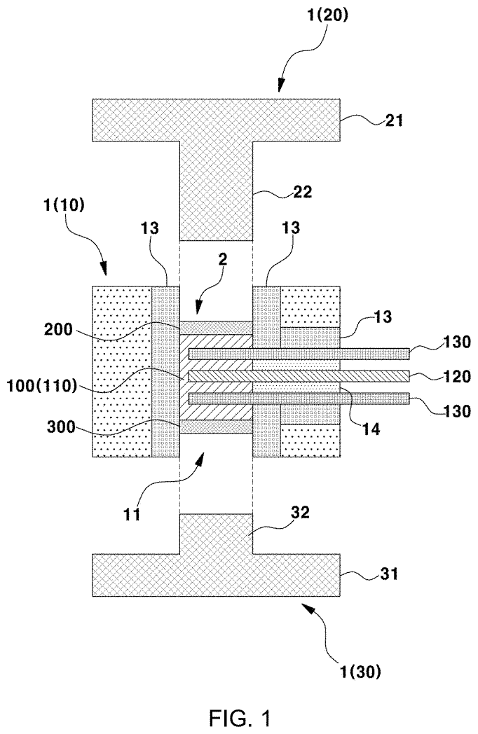

FIG. 1 shows a first embodiment of an analysis system of a lithium secondary battery according to the present disclosure. Referring to FIG. 1, the system may include: a housing 1 including a body part 10, a first conductive part positioned above the body part 10, and a second conductive part 30 positioned below the body part 10; and a lithium secondary battery 2 accommodated in the housing 1. In the first embodiment, the lithium secondary battery 2 may be a solid-state battery including a solid electrolyte.

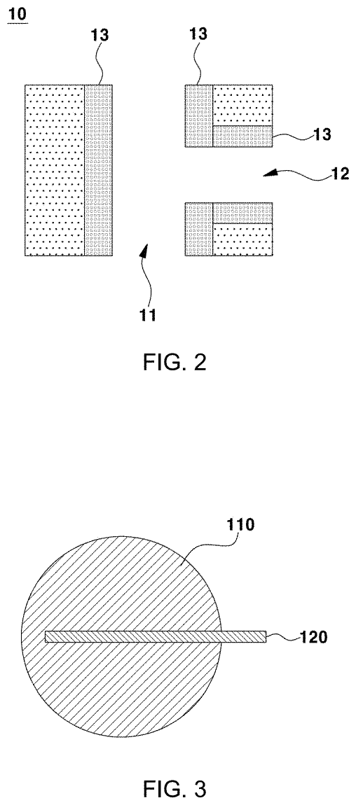

FIG. 2 shows a cross-sectional view of the body part 10 of FIG. 1. Referring to FIG. 2, the body part 10 may have a cylindrical shape and may have a first through hole 11 formed in the up-down direction through the body part 10 and a second through hole 12 formed through a side to communicate with the first through hole 11.

The body part 10 may include insulating member 13 disposed on the surfaces of the first through hole 11 and the second through hole 12. The insulating member 13 may prevent a short circuit due to electrical conduction between the first conductive part 20, the second conductive part 30, and the lithium secondary battery 2 through the body part 10. However, the body part 10 may be made of an electrically insulating material without the insulating member 13.

The first conductive part 20 may include a first substrate 21 having a plate shape, and a first protrusion member 22 protruding from the first substrate 21 in a shape corresponding to the shape of the first through hole 11.

The first substrate 21 may function as a stopper when the first conductive part 20 is inserted to the body part 10. The first substrate 21 may be a plate-shaped formed wider than the area of the first through hole 11.

The first conductive part 20 may be installed on the body part 10 with the first protrusion member 22 inserted in the first through hole 11.

The first conductive part 20 may collect a current in direct contact with a first electrode part 200 of the lithium secondary battery 2 and give a series of polarities to the first electrode part 200.

The second conductive part 30 may include a second substrate 31 having a plate shape and a second protrusion member 32 protruding from the second substrate 31 in a shape corresponding to the shape of the first through hole 11.

The second substrate 31 may function as a stopper when the second conductive part 30 is inserted to the body part 10. The second substrate 31 may be a plate-shaped formed wider than the area of the first through hole 11.

The second conductive part 30 may be installed below the body 10 with the second protrusion member 32 inserted in the first through hole 11.

The second conductive part 30 may collect a current in direct contact with a second electrode part 300 of the lithium secondary battery 2 and giving a series of polarities to the second electrode part 300.

As shown in FIG. 2, a reference electrode 120 and a SoC adjustment member 130 of the lithium secondary battery are exposed to the outside through the second through hole 12. The housing 1 may include a sealing member 14 filling a gap between the reference electrode 120 and the SoC adjustment member 130. The sealing member 14 may maintain the structure of the reference electrode 120 and the SoC adjustment member 130 during analysis.

The lithium secondary battery 2 may include an electrolyte part 100, a first electrode part 200 disposed on one side of the electrolyte part 100, and a second electrode part 300 disposed on another side of the electrolyte part 100.

The electrolyte part 100 may include a matrix 110 including a solid electrolyte, one or more reference electrodes 120 inserted in the matrix 110, and one or more SoC adjustment members 130 spaced apart from the reference electrode 120 by a predetermined distance in the thickness direction and inserted in the matrix 110.

The lithium secondary battery 2 may include a symmetric cell. That is, the first electrode part 200 and the second electrode part 300 may be electrodes including cathode active materials.

The cathode active material may be not specifically limited, but, for example, may include an oxide active material or a sulfide active material.

The sulfide active material may include a rock salt type active material such as LiCoO₂, LiMnO₂, LiNiO₂, LiVO₂, and Li₁₊ₓNi_{1/3}Co_{1/3}Mn_{1/3}O₂, a spinel type active material such as LiMn₂O₄ and Li(Ni_{0.5}Mn_{1.5})O₄, an inverse spinel type active material such as LiNiVO₄ and LiCoVO₄, an olivine type active material such as LiFePO₄, LiMnPO₄, LiCoPO₄, and LiNiPO₄, a silicon-containing active material such as Li₂FeSiO₄ and Li₂MnSiO₄, a rock salt type active material having dissimilar metal replacing a portion of transition metal such as LiNi_{0.8}Co_{(0.2-x)}AlₓO₂ (0<x<0.2), a spinel type active material having dissimilar metal replacing a portion of transition metal such as Li₁₊ₓMn_{2-x-y}M_{y}O₄ (M is at least one kind of Al, Mg, Co, Fe, Ni, Zn and 0<x+y<2), and a lithium titanate such as Li₄Ti₅O₁₂.

The sulfide active material may include copper Chevrel, iron sulfide, cobalt sulfide, nickel sulfide, etc.

Meanwhile, the first electrode part 200 and the second electrode part 300 may be electrodes including anode active materials.

The anode active material may be not specifically limited, but, for example, may include carbon active material or a metal active material.

The carbon active material may include mesocarbon microbeads (MCMB), graphite such as highly oriented pyrolytic graphite (HOPG), and amorphous carbon such as hard carbon and soft carbon.

The metal active material may include In, Al, Si, Sn, and an alloy containing at least one of these elements.

The first electrode part 200 and the second electrode part 300 may further include a solid electrolyte, a conductive additive, a binder, etc.

The solid electrolyte may include an oxide-based solid electrolyte or a sulfide-based solid electrolyte. However, a sulfide-based solid electrolyte having high conductivity for lithium ions may be used.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₘ (m and n are positive numbers and Z is one of Ge, Zn, and Ga), Li₂S—GeS₂, Li₂S—SiS₂—Li₃PO₄, Li₂S—SiS₂-LiₓMO_{y} (x and y are positive numbers and M is one of P, Si, Ge, B, Al, Ga, In), Li₁₀GeP₂S₁₂, etc.

The conductive additive may form an electron conduction path in the electrode. The conductive additive may include an sp² carbon material, such as carbon black, conducting graphite, ethylene black, and carbon nanotubes, or graphene.

The binder may include Butadiene rubber (BR), Nitrile butadiene rubber (NBR), Hydrogenated nitrile butadiene rubber (HNBR), polyvinylidene difluoride (PVDF), polytetrafluoroethylene (PTFE), carboxymethylcellulose (CMC), etc.

The electrolyte part 100 may conduct lithium ions between the first electrode part 200 and the second electrode part 300.

The matrix 110 may include a solid electrolyte, a binder, etc.

The solid electrolyte may include an oxide-based solid electrolyte or a sulfide-based solid electrolyte. However, a sulfide-based solid electrolyte having high conductivity for lithium ions may be used.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₘ (m and n are positive numbers and Z is one of Ge, Zn, and Ga), Li₂S—GeS₂, Li₂S—SiS₂—Li₃PO₄, Li₂S—SiS₂-LiₓMO_{y} (x and y are positive numbers and M is one of P, Si, Ge, B, Al, Ga, In), Li₁₀GeP₂S₁₂, etc.

The binder may include Butadiene rubber (BR), Nitrile butadiene rubber (NBR), Hydrogenated nitrile butadiene rubber (HNBR), polyvinylidene difluoride (PVDF), polytetrafluoroethylene (PTFE), carboxymethylcellulose (CMC), etc.

FIG. 3 shows the reference electrode 120 and the matrix 110 according to the first embodiment of the present disclosure.

The reference electrode 120 may be an electrode having electrochemical potential provided as a reference value for measuring the potential of one or more electrodes of an electrochemical battery.

The reference electrode 120 may have a bar shape, and a first end thereof may be inserted in the matrix 110 and a second end may be exposed to the outside through the housing 1. In detail, the second end of the reference electrode 120 may be exposed to the outside through the second through hole 12 of the housing 1.

The reference electrode 120 may be formed by coating a wire with a precious metal. The wire may include at least one selected from the group of tungsten (W), aluminum (Al), nickel (Ni), stainless steel (SUS), and a combination thereof. The precious metal may include at least one selected from the group of gold (Au), silver (Ag), white gold (Pt), and a combination thereof.

The material of the wire is not specifically limited, and any material may be used as long as it has low reactivity with the solid electrolyte described above such as tungsten (W), and aluminum (Al), nickel (Ni), and stainless steel (SUS) having strength similar to that of tungsten.

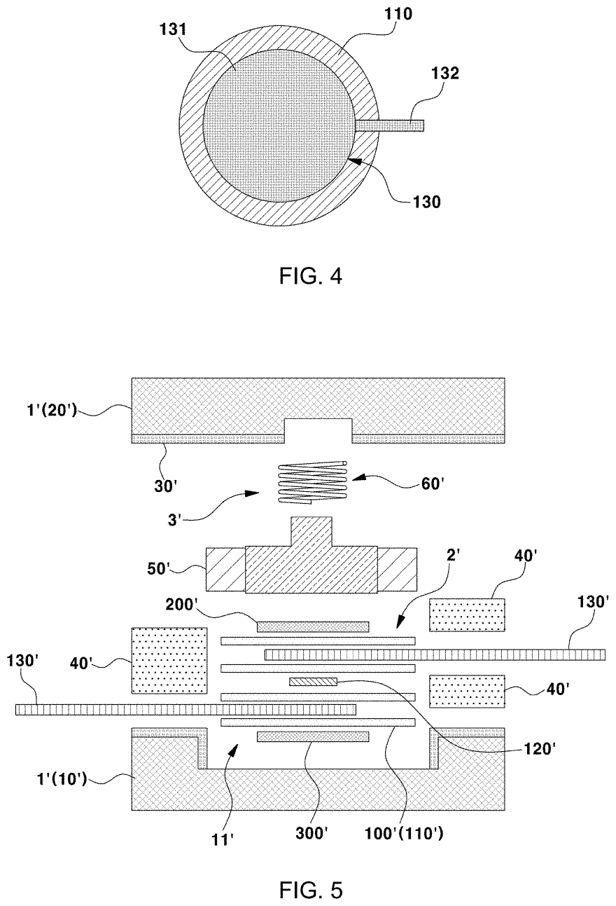

FIG. 4 shows a plan view of the SoC adjustment member 130 and the matrix 110 according to the first embodiment of the present disclosure.

The SoC adjustment member 130 may include: a plate unit 131 inserted in the matrix 110 and having a predetermined area; and an extension unit 132 having a first end connected to the flat plate unit 131 and a second end exposed to the outside through the housing 1. In detail, the extension unit 132 may be exposed to the outside through the second through hole 12 of the housing 1.

The plate unit 131 may have smaller area than the matrix 110, so the outside of the plate unit 131 is filled with the solid electrolyte. Accordingly, the plate unit 131 may not greatly influence conduction of lithium ions in the matrix 110.

The extension unit 132 may collect a current and give a series of polarities to the SoC adjustment member 130 by being exposed outside through the second through hole 12.

The SoC adjustment member 130 may include at least one selected from a group of tungsten (W), aluminum (Al), nickel (Ni), stainless steel (SUS), and a combination thereof, and may be in a metal mesh or metal foam form. The metal mesh or metal foam may be coated with a precious metal comprising at least one selected from a group of gold (Au), silver (Ag), white gold (Pt), and a combination thereof.

When the first electrode part 200 and the second electrode part 300 are symmetric cells including cathode active materials, the SoC adjustment member 130 may accommodate lithium ions moving from the first electrode part 200 and the second electrode part 300. The lithium ions may be extracted and stored on the SoC adjustment member 130.

When the first electrode part 200 and the second electrode part 300 are symmetric cells including cathode active materials, the SoC adjustment member 130 may be a lithium source that provides lithium. In this case, the SoC adjustment member 130 may be one which is pre-lithiated. The method of pre-lithiation to the SoC adjuster 130 may be not specifically limited, and for example, lithium may be plated, alloyed, or physically coated on the SoC adjustment member 130.

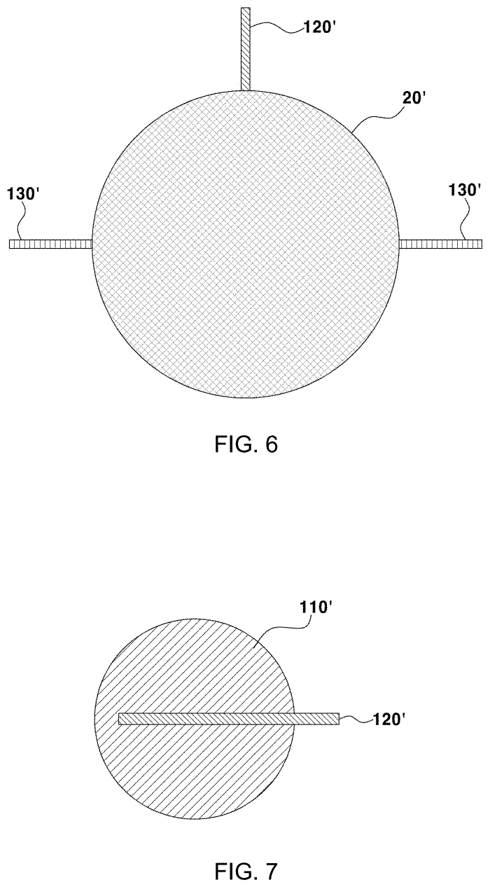

FIG. 5 shows a second embodiment of an analysis system of a lithium secondary battery according to the present disclosure. Referring to FIG. 5, the system may include a housing 1′ including a first case part 10′ and a second case part 20′, and a lithium secondary battery 2′ accommodated in the housing 1′. In the second embodiment, the lithium secondary battery 2′ may be a lithium ion battery including a liquid electrolyte.

The housing 1′ may include a first case part 10′ being open on one side and having an accommodation space 11′ therein and a second case part 20′ covering the open side of the first case part 10′.

Insulating member 30′ may be disposed at a specific position inside the first case part 10′ and/or the second case part 20′ where a possibility of contacting the first case part 10′ and/or the second case part 20′ with an electrolyte part 100′ exist. This is for preventing a short circuit in the lithium secondary battery 2′ through the housing 1′.

The first case part 10′ and the second case part 20′ may be made of an electrical conductive material. This is for providing an electron conduction path to the lithium secondary battery 2′.

A reference electrode 120′ and a SoC adjustment member 130′ of the lithium secondary battery 2′ are exposed to the outside through the joint of the first case part 10′ and the second case part 20′, so there is a risk that an internal space 11′ may communicate with the outside. Accordingly, the housing 1′ may include a sealing member 40′ positioned at the joint of the first case part 10′ and the second case part 20′ and sealing the accommodation space 11′ from the outside. The sealing member 40′ may support the reference electrode 120′ and the SoC adjustment member 130′, thereby being helpful for durability of the system.

The system may include a pressing part 3′ interposed between the housing 1′ and the lithium secondary battery 2′. The pressing part 3′ may press the elements of the lithium secondary battery 2′.

The pressing part 3′ may include a pressing member 50′ having a flat shape with a predetermined area, and an elastic member 60′ interposed between the pressing member 50′ and the housing 1′ and applying elasticity to the pressing member 50′.

The lithium secondary battery 2′ may include an electrolyte part 100′, a first electrode part 200′ disposed on one side of the electrolyte part 100′, and a second electrode part 300′ disposed on another side of the electrolyte part 100′.

The first electrode part 200′ and the second electrode part 300′ may do not include a solid electrolyte unlike the first embodiment described above. Except for this, the first and second electrode parts are the same as those of the first embodiment, so they are not described in detail.

The electrolyte part 100′ may include a matrix 110′, one or more reference electrodes 120′ inserted in the matrix 110′, and one or more SoC adjustment member 130′ spaced apart from the reference electrode 120′ by a predetermined distance in the thickness direction and inserted in the matrix 110′.

The matrix 110′ may be formed by stacking a plurality of separators having a liquid electrolyte impregnated therein.

The liquid electrolyte may include lithium salt, an organic solvent, etc.

The lithium salt may include any type as long as it is generally used in the field of the present disclosure. For example, the lithium salt may include LiPF₆, LiBF₄, LiClO₄, LiSbF₆, LiAsF₆, LiN(SO₂C₂F₅)₂, LiN(CF₃SO₂)₂, LiN(SO₃C₂F₅)₂, LiN(SO₂F)₂, LiCF₃SO₃, LiC₄F₉SO₃, LiC₆H₅SO₃, LiSCN, LiAlO₂, LiAlCl₄, LiN(CₓF₂ₓ₊₁SO₂) (CyF_{2y+1}SO₂) (where x and y are natural numbers), LiCl, LiI, LiB(C₂O₄)₂, etc.

The organic solution may include any type as long as it is generally used in the field of the present disclosure. For example, the organic salt may include a glyme-based compound, a dioxolane-based compound, a fluorinated ether-based compound, a sulfone-based compound, a carbonate-based compound, etc.

The liquid electrolyte, if necessary, may further include an electrolyte additive such as vinylene carbonate and fluoroethylene carbonate.

The reference electrode 120′ and the SoC adjustment member 130′ may be inserted between the separators.

FIG. 6 shows the analysis system of a lithium secondary battery according to the second embodiment of the present disclosure. Referring to FIG. 6, the reference electrode 120′ and the SoC adjustment member 130′ may be exposed to the outside through the housing 1′ in different directions.

FIG. 7 shows the reference electrode 120′ and the matrix 110′ according to the second embodiment of the present disclosure.

The reference electrode 120′ may have a bar shape, and an end thereof may be inserted in the matrix 110′ and another end may be exposed to the outside through the housing 1′.

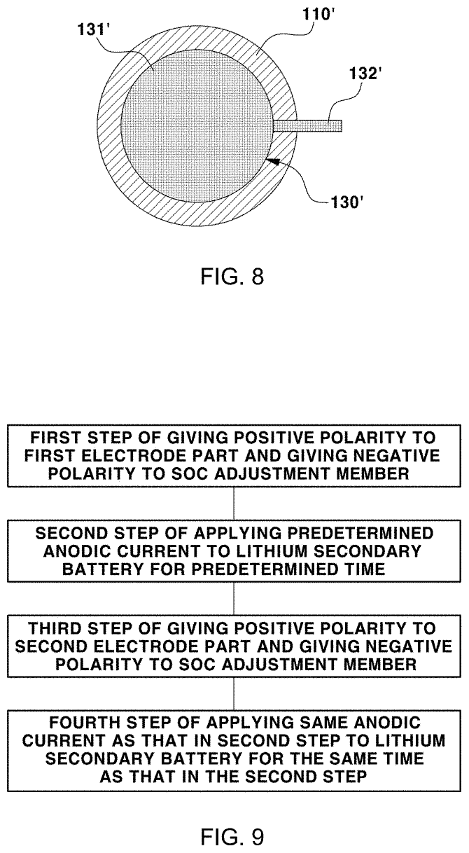

FIG. 8 shows the SoC adjustment member 130′ and the matrix 110′ according to the second embodiment of the present disclosure.

The SoC adjustment member 130′ may include: a plate unit 131′ having a flat shape with a predetermined area and inserted in the matrix 110′; and an extension unit 131′ having a first end connected to the plate unit 132′ and a second end exposed to the outside through the housing 1′.

The plate unit 131′ may have smaller area than the matrix 110′, so the outside of the plate unit 131′ is filled with a liquid electrolyte. Accordingly, the plate unit 131′ may not greatly influence conduction of lithium ions in the matrix 110′.

The materials of the reference electrode 120′ and the SoC adjustment member 130′ are substantially the same as those in the first embodiment, so they are not described below.

FIG. 9 shows a first embodiment of a method of analyzing a lithium secondary battery according to the present disclosure. In detail, the method may be an initial operation mechanism of a lithium secondary battery. The first electrode part 200 and the second electrode part 300 of the lithium secondary battery 2 may be symmetric cells including cathode active materials in the first embodiment. The analysis method may include: a first step of giving a positive polarity to the first electrode part 200 and giving a negative polarity to the SoC adjustment member 130; a second step of applying a predetermined anodic current to the lithium secondary battery 2 for a predetermined time; a third step of giving a positive polarity to the second electrode part 300 and giving a negative polarity to the SoC adjustment member 130; and a fourth step of applying the same anodic current as that in the second step to the lithium secondary battery 2 for the same time as that in the second step.

The method of giving polarities to the first electrode part 200 and the SoC adjustment member 130 in the first step and the method of giving polarities to the second electrode part 300 and the SoC adjustment member 130 in the third step are not specifically limited.

According to the analysis method, lithium of the first electrode part 200 and the second electrode part 300 is electrodeposited to the SoC adjustment member 130, whereby it is possible to adjust the state of charge (SoC) of the first electrode part 200 and the second electrode part 300. Further, since the same anodic current is applied for the same time in the second step and the fourth step, it is possible to analyze symmetric cells with the SoC of the first electrode part 200 and the second electrode part 300 equally adjusted.

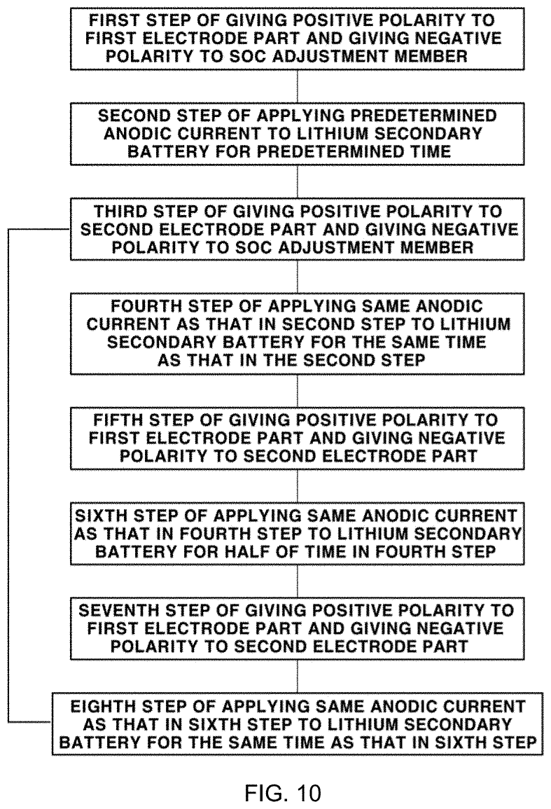

FIG. 10 shows a second embodiment of a method of analyzing a lithium secondary battery according to the present disclosure. The first electrode part 200 and the second electrode part 300 of the lithium secondary battery 2 may be symmetric cells including cathode active materials in the second embodiment.

The analysis method includes a first step of giving a positive polarity to the first electrode part 200 and giving a negative polarity to the SoC adjustment member 130, a second step of applying a predetermined anodic current to the lithium secondary battery 2 for a predetermined time, a third step of giving a positive polarity to the second electrode part 300 and giving a negative polarity to the SoC adjustment member 130, a fourth step of applying the same anodic current as that in the second step to the lithium secondary battery 2 for the same time as that in the second step, a fifth step of giving a positive polarity to the first electrode part 200 and giving a negative polarity to the second electrode part 300, a sixth step of applying the same anodic current as that in the fourth step to the lithium secondary battery 2 for a half of the time in the fourth step;

a seventh step of giving a positive polarity to the first electrode part 200 and giving a negative polarity to the second electrode part 300, and an eighth step of applying the same anodic current as that in the sixth step to the lithium secondary battery 2 for the same time as that in the sixth step. The analysis method may repeat several times the third step to the eighth step until the lithium secondary battery 2 has target SoC after the eighth step.

The analysis method may increase a SoC by oxidizing lithium of the first electrode part 200 and electrodepositing lithium to the SoC adjustment member 130, and increase a SoC of the second electrode part 300 while decreasing a SoC of the first electrode part 200 by oxidizing lithium of the second electrode part 300 and reducing the oxidized lithium in the first electrode part 200. It is possible to implement a situation of a charge/discharge cycle by repeating this process. It is possible to perform electrochemical analysis on the lithium secondary battery 2 with the SoCs of the first electrode part 200 and the second electrode part 300 adjusted to be the same after charge/discharge. That is, it is possible to perform electrochemical analysis on symmetric cells in accordance with a cycle by repeating a charge/discharge cycle and adjustment of a SoC.

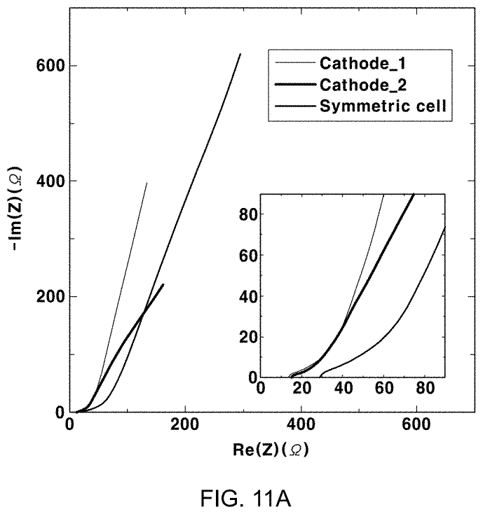

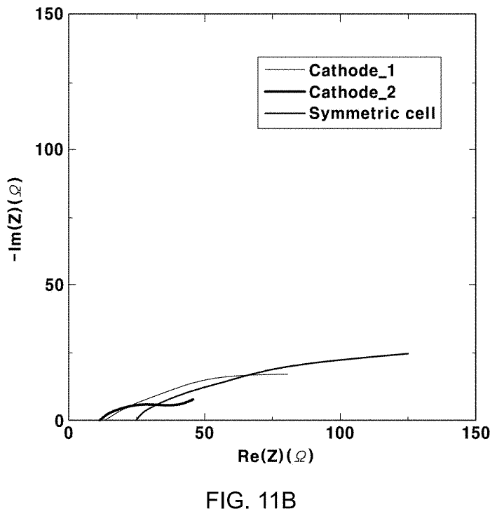

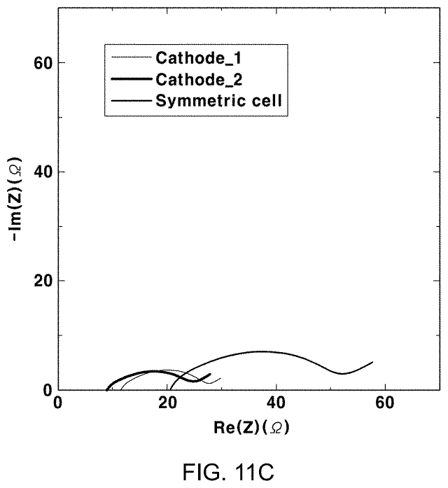

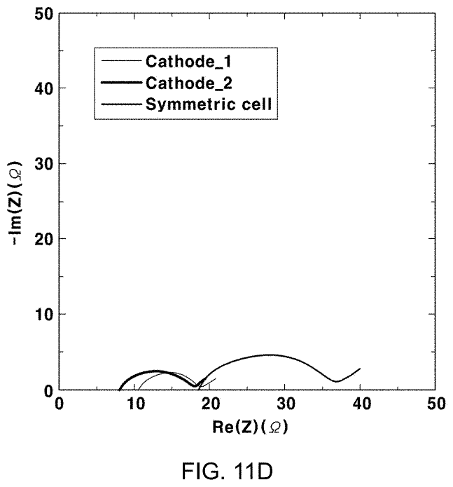

FIGS. 11A to 11D show the results of analyzing a solid-state battery using the method shown in FIG. 9. In detail, they are results of cathode resistance at the same SoC using impedance spectroscopy. FIGS. 11A to 11D show the results when a SoC was adjusted into 0, 10, 30, and 50, respectively. The SoC was determined using the SoC adjuster as a counter electrode. Cathode impedance ‘symmetric cell’ measured from one cell in a symmetric cell type and cathode impedance ‘Cathode 1 and Cathode 2’ measured in a 3-electrode cell type were shown.

It can be seen from the results that it is possible to measure resistance according a SoC in the same electrode using a symmetric cell system in which two electrode signals both exist and a 3-electrode system that can observe individual signals of electrodes, by using the analysis system and method according to the present disclosure.

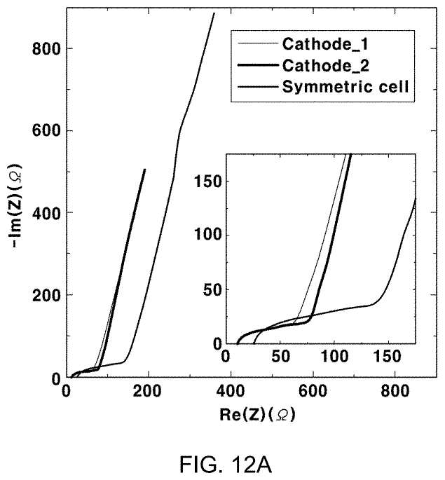

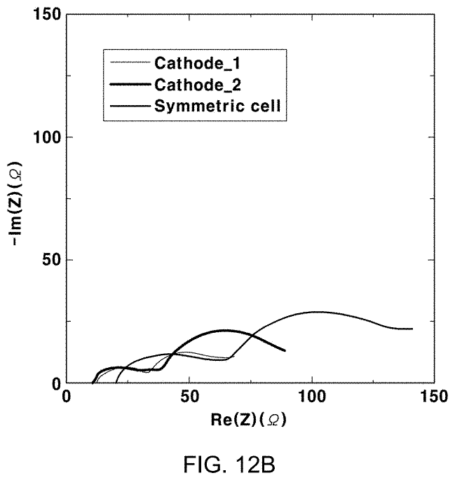

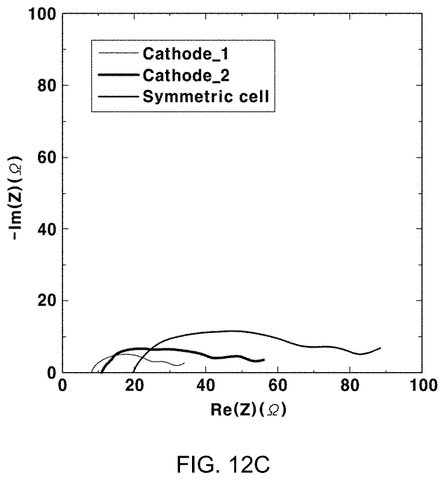

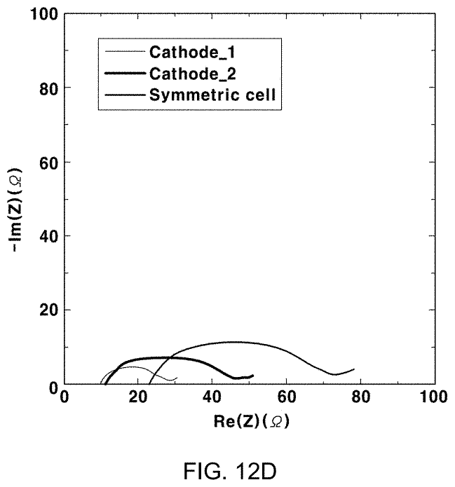

FIGS. 12A to 12D show the results of analyzing a lithium ion battery including a liquid electrolyte using the method shown in FIG. 9. In detail, they are results of cathode resistance at the same SoC using impedance spectroscopy. FIGS. 12A to 12D show the results when a SoC was adjusted into 0, 10, 30, and 50, respectively. The SoC was determined using the SoC adjuster as a counter electrode. Cathode impedance ‘symmetric cell’ measured from one cell in a symmetric cell type and cathode impedance ‘Cathode_1 and Cathode_2’ measured in a 3-electrode cell type were shown.

It can be seen from the results that it is possible to measure resistance according a SoC in the same electrode using a symmetric cell system in which two electrode signals both exist and a 3-electrode system that can observe individual signals of electrodes, by using the analysis system and method according to the present disclosure.

Embodiments were described above with reference to the limited examples and drawings, but they may be changed and modified in various ways by those skilled in the art. For example, the described technologies may be performed in order different from the described method, and/or even if components are combined or associated in different ways from the description or replaced by other components or equivalents, appropriate results can be accomplished. Therefore, other implements, other embodiments, and equivalents to the claims are included in the following claims.

What is claimed is:

1. An analysis system for a lithium secondary battery, comprising:
a housing comprising an accommodation space therein; and
a lithium secondary battery accommodated in the accommodation space of the housing and being chargeable and dischargeable,
wherein the lithium secondary battery comprises: an electrolyte part; a first electrode part disposed on one side of the electrolyte part; and a second electrode part disposed on another side of the electrolyte part, and
the electrolyte part comprises: a matrix comprising a solid electrolyte having lithium ion conductivity; one or more reference electrodes inserted in the matrix; and at least one state of charge (SoC) adjustment member inserted in the matrix and spaced apart from the reference electrode in a thickness direction by a predetermined distance.

2. The analysis system of claim 1, wherein the housing further comprises:
a body part having a cylindrical shape and having: a first through hole formed in a vertical direction therethrough and a second through hole formed on a side surface thereof, the second through hole being configured to communicate with the first through hole;
a first conductive part comprising a first substrate having a plate shape and a first protrusion member protruding from the first substrate and having a size and shape corresponding to a size and shape of the first through hole; and
a second conductive part comprising a second substrate having a plate shape and a second protrusion member protruding from the second substrate and having a size and shape corresponding to a size and shape of the second through hole,
wherein the first protruding member is inserted into the first through hole at an upper part of the body part, the second protruding member is inserted into the first through hole at a lower part of the body part, and the lithium secondary battery is positioned in a space between the first protrusion member and the second protrusion member in the first through hole.

3. The analysis system of claim 2, wherein the body part further comprises an insulating member disposed on surfaces of the first through hole and the second through hole.

4. The analysis system of claim 1, wherein the matrix comprises a solid electrolyte.

5. The analysis system of claim 1, wherein the housing further comprises:
a first case part being open on one side and having an accommodation space therein; and
a second case part covering the open side of the first case part,
wherein the lithium secondary battery is positioned in the accommodation space.

6. The analysis system of claim 5, wherein the housing further comprises a sealing member positioned at a joint of the first case part and the second case part and sealing the accommodation space.

7. The analysis system of claim 5, further comprising
a pressing part interposed between the housing and the lithium secondary battery,
wherein the pressing part comprises: a pressing member having a flat shape with a predetermined area; and an elastic member interposed between the pressing member and the housing and applying elasticity to the pressing member.

8. The analysis system of claim 1, wherein the matrix comprises a plurality of separators impregnated with electrolytes, and
the reference electrode and the at least one SoC adjustment member are inserted between the plurality of separators.

9. The analysis system of claim 1, wherein the reference electrode has a bar shape, and one end of the reference electrode is inserted in the matrix and another end of the reference electrode is exposed to the outside through the housing.

10. The analysis system of claim 1, wherein the reference electrode comprises a wire coated by a precious metal,
the wire comprises at least one of: tungsten (W), aluminum (Al), nickel (Ni), stainless steel (SUS), and/or any combination thereof, and
the precious metal comprises at least one of gold (Au), silver (Ag), platinum (Pt), and/or any combination thereof.

11. The analysis system of claim 1, wherein the at least one SoC adjustment member comprises:
a plate unit inserted in the matrix and having a predetermined area; and
an extension unit having a first end connected to the flat plate unit and a second end exposed to the outside through the housing.

12. The analysis system of claim 1, wherein the SoC adjustment member comprises at least one of: tungsten (W), aluminum (Al), nickel (Ni), stainless steel (SUS), and/or any combination thereof, and
the at least one SoC adjustment member is in a mesh form or a foam form.

13. The analysis system of claim 1, wherein the at least one SoC adjustment member is coated with a precious metal, and
the precious metal comprises at least one of: gold (Au), silver (Ag), platinum (Pt), and/or any combination thereof.

14. An analysis method for a lithium secondary battery using the analysis system of claim 1, the method comprising:
a first step of giving a positive polarity to the first electrode part and giving a negative polarity to the SoC adjustment member;
a second step of applying a predetermined anodic current to the lithium secondary battery for a predetermined time:
a third step of giving a positive polarity to the second electrode part and giving a negative polarity to the at least one SoC adjustment member; and
a fourth step of applying the same anodic current as that in the second step to the lithium secondary battery for the same amount of predetermined time as performed in the second step.

15. The analysis method of claim 14, further comprising:
a fifth step of giving a positive polarity to the first electrode part and giving a negative polarity to the second electrode part;
a sixth step of applying the same anodic current as that in the fourth step to the lithium secondary battery for a half of the amount of predetermined time in the fourth step;
a seventh step of giving a positive polarity to the first electrode part and giving a negative polarity to the second electrode part; and
an eighth step of applying the same anodic current as that in the sixth step to the lithium secondary battery for the same amount of predetermined time as that in the sixth step.

16. The analysis method of claim 15, wherein the third to eighth steps are repeated.
